(19) United States
(12) Patent Application Publication
(10) Pub. No.: US 2026/0184550 A1
(43) Pub. Date: Jul. 2, 2026

(54) SMART MOBILE ELEVATING WORK SYSTEM AND PROCESS FOR SAFE CONSTRUCTION

(71) Applicant: ADVANCED CONSTRUCTION ROBOTICS, INC., Allison Park, PA (US)

(72) Inventors: Stephen M. Muck, Butler, PA (US); Patrick A. Weber, Wexford, PA (US); Ricky A. Houghton, Wexford, PA (US)

(21) Appl. No.: 19/001,667

(22) Filed: Dec. 26, 2024

(51) Int. Cl. B66F 11/04

(52) U.S. Cl. CPC B66F 11/044; B66F 11/042

(57) ABSTRACT

Smart mobile elevating work systems and processes are disclosed. The smart mobile elevating work systems for safe construction include a chassis and an extending structure connected to the chassis. The extending structure supports a work platform. The smart mobile elevating work system autonomously limits travel of the chassis and movement of the extending structure in response to actual values, such as, mass supported by the work platform. The smart mobile elevating work process for safe construction includes providing the smart mobile elevating work system and limiting movement of the extending structure and the work platform in response to the actual.

### FIELD OF THE INVENTION

The present invention is directed to mobile elevating work platforms and systems, as well as processes incorporating such mobile elevated work platforms and systems. More particularly, the present invention is directed to smart mobile elevating work systems and processes for safe construction.

### BACKGROUND OF THE INVENTION

Mobile elevated work platforms (“MEWPs”) are ubiquitous in construction. They provide access to elevated locations that otherwise would be too difficult, costly, and/or dangerous to reach. To limit danger, the Scaffold and Access Industry Association (“SAIA”) has developed standards for design and operation of such MEWPs. One standard, ANSI/SAIA A92.20-2020, entitled “Design, Calculations, Safety Requirements and Test Methods for Mobile Elevating Work Platforms (MEWPs),” which is incorporated by reference, defines specific limitations to facilitate safety.

Failure to safely operate MEWPs can cause damage to property, damage to MEWPs, injury to operators, injury to bystanders, and/or death to operators and/or bystanders. To prevent those, MEWPs traditionally operate with specific ratings that apply based upon design tests applying the ANSI/SAIA standard(s). Such design tests can restrict use of the MEWPs in a manner that causes difficulty for operators, which can cause additional time and power to be used when the restricted use interrupts desired actions by the operator. The restrictions can also cause operators to make bad decisions that can result in injury or death.

Platforms, systems, and processes that do not suffer from such drawbacks would be desirable in the art.

### BRIEF DESCRIPTION OF THE INVENTION

In an embodiment, a smart mobile elevating work system for safe construction includes a chassis configured for the smart mobile elevating work system to travel from a first position to a second position and an extending structure connected to the chassis and supporting a work platform, the extending structure configured for movement of the work platform. The smart mobile elevating work system autonomously limits the travel and the movement in response to actual values for the travel of the chassis, the movement of the extending structure, work platform mass, and additional mass of anything supported by the work platform.

In another embodiment, smart mobile elevating work system for safe construction includes a chassis and an extending structure connected to the chassis, the extending structure supporting a work platform. The smart mobile elevating work system further includes means for limiting movement of the extending structure and the work platform in response to actual values for movement of the extending structure and mass supported by the work platform.

In another embodiment, a smart mobile elevating work process for safe construction includes providing a smart mobile elevating work system having a chassis and an extending structure connected to the chassis, the extending structure supporting a work platform, and limiting movement of the extending structure and the work platform in response to actual values for movement of the extending structure and mass supported by the work platform.

Other features and advantages of the present invention will be apparent from the following more detailed description, taken in conjunction with the accompanying drawings which illustrate, by way of example, the principles of the invention.

### BRIEF DESCRIPTION OF THE DRAWINGS

FIG. 1 shows embodiments of a smart mobile elevating work system and a smart mobile elevating work process showing movement of an extending structure, according to the disclosure.

FIG. 2 shows an embodiment of a smart mobile elevating work system having a stabilizing device, according to the disclosure.

FIG. 3 shows embodiments of a smart mobile elevating work system and a smart mobile elevating work system process showing travel of a chassis, according to the disclosure.

FIG. 4 shows a diagram associated with chassis stability for a smart mobile elevating work system process, according to the disclosure.

Wherever possible, the same reference numbers will be used throughout the drawings to represent the same parts.

### DETAILED DESCRIPTION OF THE INVENTION

Provided are platforms, systems, and processes, according to embodiments of the disclosure. Embodiments of the present disclosure, for example, in comparison to concepts failing to include one or more of the features disclosed herein, permit MEWPs to be used more efficiently while remaining safe, permit MEWPs to operate with expanded ranges, permit operators to use MEWPs with less gasoline/electricity, permit MEWPs to have dynamic ratings, permits operator to continue using systems when traditional MEWPs would automatically and unnecessarily be shut down for violating a rating and/or ANSI/SAIA A92.20-2020, or permit a combination thereof.

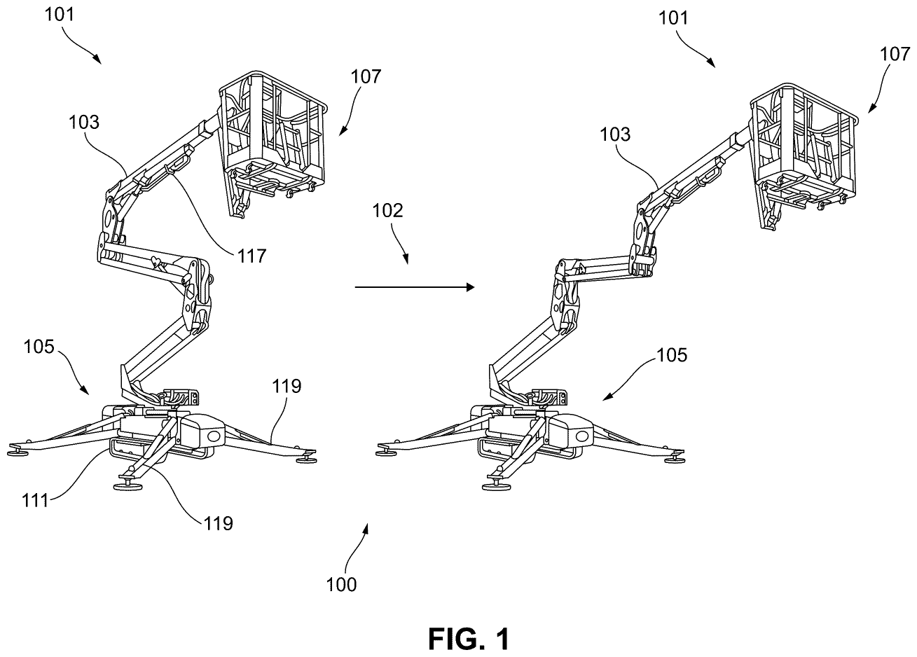

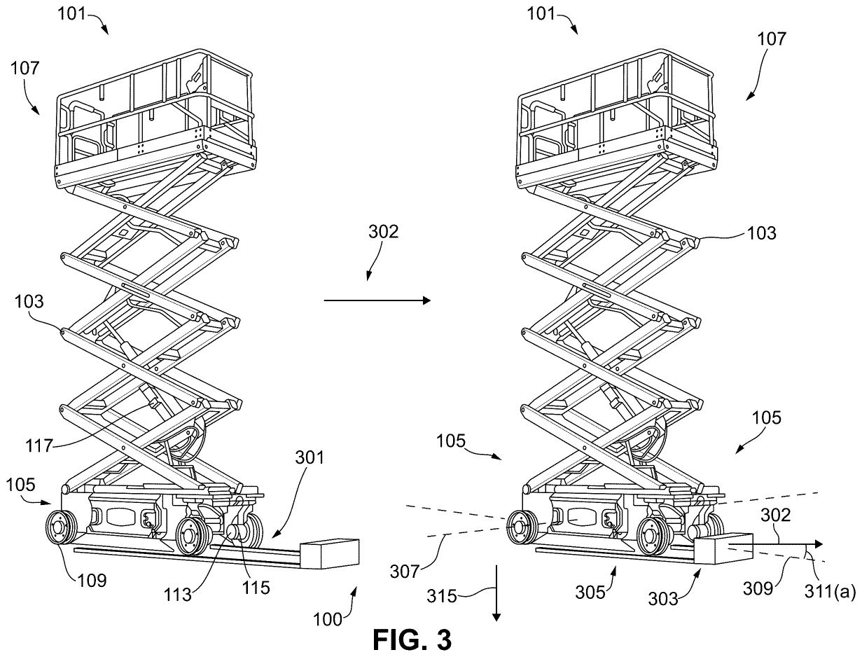

Referring to FIG. 1, according to an embodiment, a smart mobile elevating work system 101 is configured for a process 100 including movement (step 102) of an extending structure 103 to move a work platform 107 and travel 302 (see FIG. 3) of a chassis 105 from a first position 301 to a second position 303. The smart mobile elevating work system 101 includes the extending structure 103, the chassis 105, and the work platform 107. The extending structure 103 is connected to the chassis 105 and supports the work platform 107.

The movement (step 102) of the extending structure 103 is able to be complex as shown in FIG. 1, for example, with the smart mobile elevating work system 101 being an articulating boom lift, a telescoping boom lift, a towable boom lift, or a combination thereof. Additionally or alternatively, the movement (step 102) is able to be unidirectional or substantially unidirectional, for example, with a scissor lift as the smart mobile elevating work system 101 as in FIG. 3.

The movement (step 102) of the extending structure 103 has a velocity and an acceleration. The velocity is within ANSI/SAIA A92.20-2020, for example, being equal to or less than 0.8 meters per second, or in violation of ANSI/SAIA A92.20-2020, for example, being greater than 0.8 meters per second.

In one embodiment, the velocity of the movement (step 102), for example, being an extending or retracting motion, is between 0 and 0.8 meters per second, between 0 and 1 meters per second, between 0 and 2 meters per second, between 0 and 3 meters per second, between 0 and 4 meters per second, between 0 and 5 meters per second, between 0.5 and 1 meters per second, between 0.5 and 2 meters per second, between 0.5 and 3 meters per second, between 0.5 and 4 meters per second, between 0.5 and 5 meters per second, between 0.8 and 1 meters per second, between 0.8 and 2 meters per second, between 0.8 and 3 meters per second, between 0.8 and 4 meters per second, between 0.8 and 5 meters per second, between 1 and 2 meters per second, between 1 and 3 meters per second, between 1 and 4 meters per second, between 1 and 5 meters per second, or any suitable combination, sub-combination, range, or sub-range therein.

In one embodiment, the velocity of the movement (step 102), for example, being a slewing or rotational motion, is between 0 and 1.4 meters per second, between 0 and 2 meters per second, between 0 and 3 meters per second, between 0 and 4 meters per second, between 0 and 5 meters per second, between 1 and 2 meters per second, between 1 and 3 meters per second, between 1 and 4 meters per second, between 1 and 5 meters per second, between 1.4 and 2 meters per second, between 1.4 and 3 meters per second, between 1.4 and 4 meters per second, between 1.4 and 5 meters per second, between 1 and 2 meters per second, between 1 and 3 meters per second, between 1 and 4 meters per second, between 1 and 5 meters per second, or any suitable combination, sub-combination, range, or sub-range therein.

In a further embodiment, the acceleration or deceleration of the movement (step 102) of the extending structure 103 is identified and further limits the movement (step 102), for example, as a ratio of gravity (approx. 9.8 m/s²). Suitable ratios include between 0 and 0.25 times gravity, between 0.1 and 0.3 times gravity, between 0.2 and 0.3 times gravity, between 0.1 and 0.5 times gravity, between 0.25 and 0.5 times gravity, or any suitable combination, sub-combination, range, or sub-range therein.

Referring to FIG. 3, the travel (step 302) of the chassis 105 from the first position 301 to the second position 303 is within ANSI/SAIA A92.20-2020, for example, being equal to or less than 1.7 meters per second, or in violation of ANSI/SAIA A92.20-2020, for example, being greater than 1.7 meters per second. In one embodiment, the velocity is between 0 and 1.7 meters per second, between 0 and 2 meters per second, between 0 and 3 meters per second, between 0 and 4 meters per second, between 0 and 5 meters per second, between 1.5 and 2 meters per second, between 1.5 and 3 meters per second, between 1.5 and 4 meters per second, between 1.5 and 5 meters per second, between 1.7 and 2 meters per second, between 1.7 and 3 meters per second, between 1.7 and 4 meters per second, between 1.7 and 5 meters per second, between 1 and 2 meters per second, between 1 and 3 meters per second, between 1 and 4 meters per second, between 1 and 5 meters per second, or any suitable combination, sub-combination, range, or sub-range therein.

In a further embodiment, the acceleration or deceleration of the travel (step 302) of the chassis 105 is identified and further limits the travel (step 302), for example, as a ratio of gravity (approx. 9.8 m/s²). Suitable ratios include between 0 and 0.25 times gravity, between 0.1 and 0.3 times gravity, between 0.2 and 0.3 times gravity, between 0.1 and 0.5 times gravity, between 0.25 and 0.5 times gravity, or any suitable combination, sub-combination, range, or sub-range therein.

The smart mobile elevating work system 101 is for safe construction, specifically, building, repairing, cleaning, and/or demolishing of structures such as residential structures (for example, houses, townhouses, apartment buildings, dormitories, and/or other similar structures), commercial structures (for example, malls, restaurants, grocery stores, hotels, parking structures, and/or stadiums), institutional structures (for example, libraries, court houses, government facilities, schools, museums, hospitals, military buildings, fire stations, police stations, and/or prisons), industrial structures (for example, warehouse and distribution centers, manufacturing facilities, power plants, water towers, wind farms, solar arrays, data centers, chemical processing facilities, and/or mining facilities), civil structures (for example, bridge decks, elevated superstructures, rail systems, roads, runways, tunnels, marine piers, and/or ramps), and/or any other suitable structures, groupings of structures, or construction projects. As used herein, the term “construction” is not intended to encompass active fire fighting activities, operation of fairground equipment, operation of digger derricks, operation of industrial trucks, operation of forklifts, operation of telehandlers, operation of aircraft ground support equipment, or operation of permanently installed units/systems. As will be appreciated by those skilled in the art, such concepts are within the present disclosure but beyond the scope of being for safe construction.

The chassis 105 is a mobile unit capable of lateral movement and supporting elevation. The chassis 105 is not intended to encompass commercial vehicles, digger derricks, fairground equipment, forklifts, telehandlers, fire trucks, aircraft support equipment, or permanently installed systems. The chassis 105 is powered by any suitable sources, such as, liquid fuels (for example, petroleum, diesel, gasoline, kerosene, coal tar, liquefied petroleum gas, naphtha, and/or ethanol), gaseous fuels (for example, natural gas, hydrogen, propane, methane, and/or compressed natural gas), and/or electricity (wired or battery). The chassis 105 has controls on it, onsite, remote, and/or on the work platform 107. The chassis 105 is capable of traversing uneven or unstable ground as well as stable ground.

The smart mobile elevating work system 101 and the process 100 reduce or eliminate predetermined unsafe operating conditions. In one embodiment, the predetermined unsafe operation conditions include one or more operational risks, for example, causing the work platform 107 to be unstable, causing the work platform 107 to fall, causing the work platform 107 to be uncontrolled, tipping the chassis 105, causing the chassis 105 to shift, causing uncontrolled movement of the chassis 105, causing the extending structure 103 to be unstable, causing the extending structure 103 to fall, causing the extending structure 103 to be uncontrolled, or any suitable combination or sub-combination thereof. Additionally or alternatively, in one embodiment, the predetermined unsafe operation conditions include one or more proximity-based risks, for example, causing the work platform 107, the extending structure 103, and/or the chassis 105 to be too close to an electrical source, to be too close to an overhang, to be too close to an obstruction, to be too close to unstable ground, to be too close to water, or any suitable combination or sub-combination thereof.

According to the process 100, the smart mobile elevating work system 101 autonomously controls/limits the movement (step 102, FIG. 1) and the travel (step 302, FIG. 3) through actual values, for example, incorporated into a mathematic equation. In one embodiment, the actual values are for the travel (step 302) of the chassis 105, the movement (step 102) of the extending structure 103, mass of the chassis 105 (chassis mass), mass of the extending structure 103 (extending structure mass), mass of the work platform 107 (work platform mass), additional mass of anything supported by the work platform 107, or combinations thereof. As used herein, the term “actual” as it relates to “actual values” is intended to encompass values captured through measurement or detection of conditions during use of the smart mobile elevating work system 101, thereby enabling dynamic operation. The term is not intended to encompass projected values used for providing ratings of multiple MEWPs.

In some embodiments, the actual values include wind speed, strength of materials used in the smart mobile elevating work system 101, ambient temperature, ambient pressure, ambient weather conditions, speed of the travel (step 302), acceleration of the travel (step 302), speed of the movement (step 102), acceleration of the movement (step 102), direction of the travel (step 302), direction of the movement (step 102), relative position of the chassis 105 compared to the work platform 107, tire 109 (FIG. 3) or tread 111 (FIG. 1) failure, pressure of the tire(s) 109, power failure, transmission failure, kick-back, drive 113 (FIG. 3) failure, brake 115 (FIG. 3) failure, chain tension changes, wear, stress, disengagement, mechanical failure, winch positioning, hydraulics 117 parameters, ambient topography 305 (FIG. 3), information relating to preventative maintenance schedules (such as for wear schedules/predictions), information corresponding with a job hazard analysis, or any suitable combination thereof.

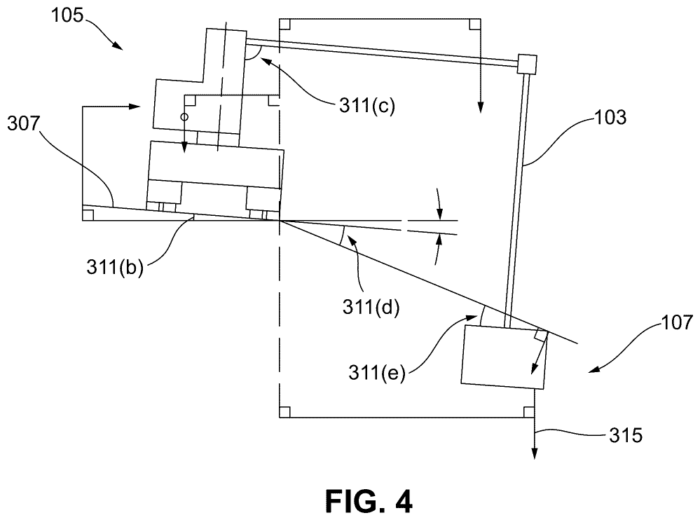

Referring to FIGS. 3-4, in one embodiment, the chassis 105 has a transverse axis 307 and a longitudinal axis 309 (FIG. 3) defining the overall tilt (or lack thereof) of the chassis 105 relative to gravity 315. In a further embodiment, one or more angles 311 relative to the chassis 105, e.g., 311(a) and 311(b), the extending structure 103, e.g., 311(c), and the platform 107, e.g., 311(d) and 311(e), are incorporated into the mathematical equation to provide stability.

For example, the transverse axis 307 defines the angle 311(b) as a transverse angle (or no angle) of the chassis 105 relative to a perpendicular of the direction of the travel (step 302). The longitudinal axis 309 defines the angle 311(a) as a longitudinal angle (or no angle) of the chassis 105 relative to the direction of the travel (step 302). In further embodiments, the angle(s) 311 is/are between 1 and 5 degrees, between 2 and 5 degrees, between 3 and 5 degrees, between 4 and 5 degrees, between 2 and 3 degrees, between 2 and 4 degrees, between 2 and 5 degrees, between 3 and 4 degrees, between 3 and 5 degrees, between 4 and 5 degrees, or any suitable combination, sub-combination, range, or sub-range therein.

The process 100 is computer-implemented. This means the process 100 is implemented in digital electronic circuitry or in computer software, firmware, or hardware, including the structures disclosed in this specification or in combinations of one or more of them.

In one embodiment, the process 100 is implemented as operations performed by a data processing apparatus on data stored on one or more computer-readable storage devices or received from other sources.

In one embodiment, the data processing apparatus, computer, or computing device encompasses apparatus, devices, and machines for processing data, including, by way of example, a programmable processor, a computer, a system on a chip or multiple ones, or combinations, of the foregoing.

In one embodiment, the smart mobile elevating work system 101 includes special purpose logic circuitry, for example, a central processing unit (CPU), a parallel graphics processing unit (GPU), a field programmable gate array (FPGA), an application-specific integrated circuit (ASIC), language processing unit (LPU), a neural processing unit (NPU), Tensor Processing Unit (TPU), or a combination thereof

In one embodiment, the smart mobile elevating work system 101 includes code that creates an execution environment for the computer program in question, for example, code that constitutes processor firmware, a protocol stack, a database management system, an operating system (for example, an operating system or a combination of operating systems), a cross-platform runtime environment, a virtual machine, or a combination of one or more of them.

In one embodiment, the smart mobile elevating work system 101 and execution environment realize various different computing model infrastructures, such as web services, cloud computing, distributed computing and grid computing infrastructures.

As used herein, a “computer program” refers to an executable program of instructions able to be executed on one computer or on multiple computers that are located at one site or distributed across multiple sites and interconnected by a communication network. Generally, a computer also includes, or is operatively coupled to receive data from or transfer data to, or both, one or more mass storage devices for storing data. A computer, or node, is capable of being embedded in another device, for example, a mobile device, a personal digital assistant (PDA), a game console, a Global Positioning System (GPS) receiver, or a portable storage device. Devices suitable for storing computer program instructions and data include non-volatile memory, media and memory devices, including, by way of example, semiconductor memory devices, magnetic disks, and magneto-optical disks. The processor and the memory are capable of being supplemented by, or incorporated in, special-purpose logic circuitry. Additionally, processors for execution of a computer program include, by way of example, both general-purpose and special-purpose microprocessors, and any one or more processors of any kind of digital computer. Generally, a processor receives instructions and data from a read-only memory or a random-access memory or both. The essential elements of a computer are a processor for performing actions in accordance with instructions and one or more memory devices for storing instructions and data.

In one embodiment, the process 100 of the smart mobile elevating work system 101 autonomously controlling/limiting the movement (step 102) and the travel (step 302) through the mathematic equation is executed according to such operations. The mathematic equation allows the travel (step 302) and the movement (step 102) to have dynamic configuration ratings. As used herein, the term “configuration ratings” or grammatic variations thereof refers to safe conditions able to be validated as not causing the smart mobile elevating work system 101 to cause the predetermined unsafe operating conditions. Dynamic configuration ratings incorporate the actual values.

In one embodiment, the quantity of the dynamic configuration ratings are equal to or greater than one hundred, one thousand, ten thousand, one hundred thousand, one million, one billion, one trillion, one quadrillion, one centillion, infinite, or any suitable combination, sub-combination, range, or sub-range therein.

Referring to FIG. 1, in one embodiment, the chassis 105 includes one or more stabilization legs 119. The smart mobile elevating work system 101 autonomously controls/limits the movement (step 102, FIG. 1) and the travel (step 302, FIG. 3) in response to the position of the stabilization legs 119. For example, in a first stabilization leg configuration, with the stabilization legs 119 positioned for stabilizing the smart mobile elevating work system 101 as shown in FIG. 1, the movement (step 102) has a greater range than without the stabilization legs 119 being positioned for the stabilizing and the travel (step 302) is not permitted to occur. In a second stabilization leg configuration, with the stabilization legs 119 withdrawn from the stabilizing, the movement (step 102) has a narrower range and the travel (step 302) is able to occur.

The stabilization legs 119, and/or other outriggers, are manually positioned or are powered. In one embodiment with the stabilization legs 119 being powered, the smart mobile elevating system 101 adjusts the stabilization legs 119 in response to the movement (step 102) and/or the travel (step 302). To adjust the stabilization legs 119 in response to the movement (step 102), a portion or all of the stabilization legs 119 are partially or fully extended or retracted to reduce or eliminate the predetermined unsafe conditions.

In one embodiment, in a first stabilizing leg configuration, with the stabilizing legs 119 positioned for stabilizing the smart mobile elevating work system 101 as shown in FIG. 1, the movement (step 102) has a greater range than without the stabilizing legs 119 being positioned for the stabilizing and the travel (step 302) is not permitted to occur.

In one embodiment, to adjust the stabilization legs 119 during the travel (step 302), a portion or all of the stabilization legs 119 are partially extended or retracted to reduce or eliminate the predetermined unsafe conditions, for example, thereby balancing the smart mobile elevating system 101.

In one embodiment, in a second stabilizing leg configuration, with the stabilizing legs 119 withdrawn from the stabilizing, the movement (step 102) has a narrower range and the travel (step 302) is able to occur.

As will be appreciated by those skilled in the art, additional similar concept are able to be used in response to the movement (step 102) and/or the travel (step 302), for example, weight balancing mechanism, such as, fluid/fuel reservoirs being shifted, to facilitate stability, especially in emergency situations.

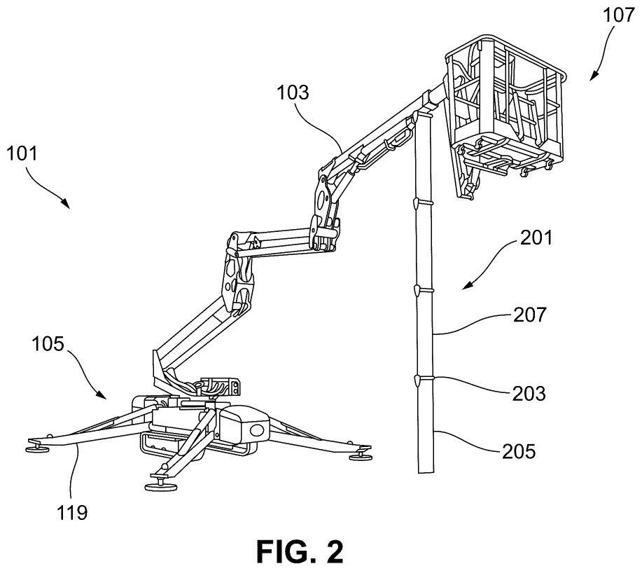

Referring to FIG. 2, in one embodiment, the extending structure 103 includes one or more stabilizing devices 201 that are not stabilization legs or outriggers. The smart mobile elevating work system 101 autonomously controls/limits the movement (step 102, FIG. 1) and the travel (step 302, FIG. 3) in response to the position of the stabilizing device(s) 201.

The stabilizing device 201 shown in FIG. 2, in one embodiment, includes a lower section 205 and an upper section 207, coupled at a coupling region 203. The stabilizing device 201 is able to be disengaged manually or autonomously, for example, by using any suitable internal mechanism, such as, a pulley system, magnets, electromagnets, threading, mating interfaces, hydraulics, or a combination thereof.

In one embodiment, in a first stabilizing device configuration, with the stabilizing device(s) 201 positioned for stabilizing the smart mobile elevating work system 101 as shown in FIG. 2, the movement (step 102) has a greater range than without the stabilizing device 201 being positioned for the stabilizing and the travel (step 302) is not permitted to occur.

In one embodiment, in a second stabilizing device configuration, with the stabilizing device 119 withdrawn from the stabilizing, the movement (step 102) has a narrower range and the travel (step 302) is able to occur.

The extending structure 103 operates through any suitable mechanisms, such as hydraulics, cables, chains, telescoping configurations, mechanical interfaces, or a combination thereof. The range directly opposite of the gravity 315 is highest based upon the actual values, for example, incorporated into the mathematical equation operating the smart mobile elevating work system 101. The range directly perpendicular to the direction of the gravity 315 is lowest based upon the actual values, for example, incorporated into the mathematical equation operating the smart mobile elevating work system 101.

As will be appreciated by those skilled in the art, the range of the extending structure 103 is dynamic based upon the actual values provided during operation of the smart mobile elevating work system 101. Suitable ranges include, but are not limited to, between 0 meters and 10 meters, between 0 meters and 15 meters, between 0 meters and 20 meters, between 0 meters and 30 meters, between 0 meters and 40 meters, between 0 meters and 50 meters, between 0 meters and 60 meters, between 0 meters and 70 meters, between 10 meters and 15 meters, between 10 meters and 20 meters, between 10 meters and 30 meters, between 10 meters and 40 meters, between 10 meters and 50 meters, between 10 meters and 60 meters, between 10 meters and 70 meters, between 20 meters and 30 meters, between 20 meters and 40 meters, between 20 meters and 50 meters, between 20 meters and 60 meters, between 20 meters and 70 meters, between 30 meters and 40 meters, between 30 meters and 50 meters, between 30 meters and 60 meters, between 30 meters and 70 meters, between 40 meters and 50 meters, between 40 meters and 60 meters, between 40 meters and 70 meters, between 50 meters and 60 meters, between 50 meters and 70 meters, between 60 meters and 70 meters, or any suitable combination, sub-combination, range, or sub-range therein.

Similarly, in one embodiment, the maximum mass of the extending structure 103 directly opposite of the gravity 315 is highest based upon the actual values, for example, incorporated into the mathematical equation operating the smart mobile elevating work system 101. The maximum mass of the extending structure 103 directly perpendicular to the direction of the gravity 315 is lowest based upon the actual values, for example, incorporated into the mathematical equation operating the smart mobile elevating work system 101.

As will be appreciated by those skilled in the art, the maximum mass of the extending structure 103 is dynamic based upon the actual values provided during operation of the smart mobile elevating work system 101. Suitable ranges include, but are not limited to, between 0 kg and 500 kg, between 100 kg and 500 kg, between 200 kg and 500 kg, between 300 kg and 500 kg, between 400 kg and 500 kg, between 0 kg and 400 kg, between 100 kg and 400 kg, between 200 kg and 400 kg, between 300 kg and 400 kg, between 0 kg and 300 kg, between 100 kg and 300 kg, between 200 kg and 300 kg, between 0 kg and 200 kg, between 100 kg and 200 kg, between 0 kg and 100 kg, or any suitable combination, sub-combination, range, or sub-range therein.

The work platform 107 includes any suitable features. Suitable features for the work platform 107 include a ladder, one or more rails, one or more grates, a main platform, an extension platform, protection on all sides, a bucket, a mechanism for weight distribution, a drive system interface, controls, a braking system interface, fastening mechanisms, folding guardrails, a lateral door (inward or outward facing), a trapdoor, a lifting attachment, storage for tools, tools, or any suitable combination thereof. The work platform 107 includes non-flammable and non-conductive materials, for example, with drain holes and/or access openings.

In one embodiment, the mass, position, movement, and the actual values in general associated with the work platform 107 are incorporated into the process 100, for example, using the mathematic equation based upon the actual values.

In one embodiment, the work platform 107 includes active systems for achieving the process 100. Suitable active systems include self-level mechanisms such as gyroscopes (for example, rotating in response to a persistent wind), emergency stabilization mechanisms (for example, an air bag, a parachute, a drone, and/or a compressed-air flow mechanism autonomously activated), vibration dampening (for example, allowing stable welding, stable painting, and/or stable cutting), or a combination thereof.

In one embodiment, the work platform 107 includes an electric emergency response system, for example, based upon sensing, measuring, or detecting an electric/static field or based upon detecting a location being close to a predetermined electric/static hazard (for example, high tension wires). The electric emergency response system actuates an alarm, removes power from the work platform 107, and/or repositions the work platform 107.

### EXAMPLES

In a first example, a comparative example, a comparative MEWP operates based upon a pre-set mass rating for the work platform, specifically 100 kg. The pre-set mass rating is a calculation from the manufacturer consistent with ANSI/SAIA A92.20-2020. The pre-set mass rating is exceeded with a load of 110 kg supported by the work platform. In response, an alarm is activated and/or operation of the MEWP is limited.

In a second example, consistent with an embodiment of the disclosure, the mobile elevating work system 101 operates based upon the actual values of the travel (step 302) of the chassis 105, the movement (step 102) of the extending structure 103, work platform mass 107, and additional mass of anything supported by the work platform 107. The travel (step 302) of the chassis 105 is at 0.1 meters per second with the angle 311(a) defined with respect to the longitudinal axis 309 being 2 degrees tilted forward and the angle 311(b) defined with respect to the transverse axis 307 being 0 degrees. The movement (step 102) of the extending structure 103 is to the rear of the chassis 105. The pre-set mass rating of the comparative MEWP of the first example is exceeded with a load of 110 kg supported by the work platform. In response, the mobile elevating work system 101 autonomously limits the travel (step 302) and the movement (102) to a mass greater than the pre-set mass rating of the comparative MEWP of the first example in response to the actual values, and no alarm is activated.

In a third example, a comparative example, a comparative MEWP operates based upon a pre-set extending structure position/range rating for the extending structure, specifically 30 meters perpendicular to the gravity 315. The pre-set extending structure position/range rating is a calculation from the manufacturer consistent with ANSI/SAIA A92.20-2020. The pre-set extending structure position/range is met by the extending structure. In response, an alarm is activated and/or operation of the MEWP is limited.

In a fourth example, consistent with an embodiment of the disclosure, the mobile elevating work system 101 operates based upon the actual values of the travel (step 302) of the chassis 105, the movement (step 102) of the extending structure 103, work platform mass 107, and additional mass of anything supported by the work platform 107. The travel (step 302) of the chassis 105 is at 0 meters per second with the longitudinal angle 311(a) being 0 degrees and the transverse angle 311(b) being 5 degrees to the left side of the chassis 105. The movement (step 102) of the extending structure 103 is to the right side of the chassis 105. The pre-set extending structure position/range rating of the comparative MEWP of the third example is exceeded with position/range of 31 meters to the right of the chassis 105. In response, the mobile elevating work system 101 autonomously limits the travel (step 302) and the movement (102) to a position/range greater than the pre-set extending structure position/range of the comparative MEWP of the third example in response to the actual values, and no alarm is activated.

In a fifth example, a comparative example, a comparative MEWP operates based upon a pre-set chassis angle rating for the chassis, specifically 5 degrees. The pre-set chassis angle rating is a calculation from the manufacturer consistent with ANSI/SAIA A92.20-2020. The pre-set chassis angle rating is met or exceeded with the chassis being oriented at 6 degrees. In response, an alarm is activated and/or operation of the MEWP is limited.

In a sixth example, consistent with an embodiment of the disclosure, the mobile elevating work system 101 operates based upon the actual values of the travel (step 302) of the chassis 105, the movement (step 102) of the extending structure 103, work platform mass 107, and additional mass of anything supported by the work platform 107. The travel (step 302) of the chassis 105 is at 0.5 meters per second with the longitudinal angle 311(a) being 0 degrees and the transverse angle 311(b) being 6 degrees to the left side of the chassis 105. The movement (step 102) of the extending structure 103 is to the right side of the chassis 105. The pre-set chassis angle rating of the comparative MEWP of the fifth example is exceeded with the transverse angle 311(b) being 6 degrees. In response, the mobile elevating work system 101 continues to allow the travel (step 302) and limits the movement (102) to remain on the right side of the chassis 105 in response to the actual values, and no alarm is activated.

While the invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In addition, all numerical values identified in the detailed description shall be interpreted as though the precise and approximate values are both expressly identified.

What is claimed is:

1. A smart mobile elevating work system for safe construction, comprising:
a chassis configured for the smart mobile elevating work system to travel from a first position to a second position; and
an extending structure connected to the chassis and supporting a work platform, the extending structure configured for movement of the work platform;
wherein the smart mobile elevating work system autonomously limits the travel and the movement in response to actual values for the travel of the chassis, the movement of the extending structure, work platform mass, and additional mass of anything supported by the work platform.

2. The smart mobile elevating work system of claim 1, wherein the smart mobile elevating work system eliminates predetermined unsafe operating conditions.

3. The smart mobile elevating work system of claim 1, wherein the smart mobile elevating work system allows for the travel and the movement to have at least one hundred dynamic configuration ratings.

4. The smart mobile elevating work system of claim 1, wherein the smart mobile elevating work system allows for the travel and the movement to have at least one million dynamic configuration ratings.

5. The smart mobile elevating work system of claim 1, wherein the smart mobile elevating work system allows for the travel and the movement to have at least one billion dynamic configuration ratings.

6. The smart mobile elevating work system of claim 1, wherein the smart mobile elevating work system allows for the travel and the movement to have infinite dynamic configuration ratings.

7. The smart mobile elevating work system of claim 1, wherein the actual values further include wind speed, speed of the movement, acceleration of the movement, direction of the movement, relative position of the chassis compared to the work platform, and electric fields proximal to the work platform.

8. The smart mobile elevating work system of claim 1, wherein the actual values further include wind speed, strength of materials used in the smart mobile elevating work system, ambient temperature, ambient pressure, ambient weather conditions, speed of the travel, acceleration of the travel, speed of the movement, acceleration of the movement, direction of the travel, direction of the movement, relative position of the chassis compared to the work platform, tire failure, tire pressure, power failure, transmission failure, kick-back, drive failure, brake failure, chain tension changes, wear, stress, disengagement, mechanical failure, winch positioning, hydraulics parameters, and ambient topography.

9. The smart mobile elevating work system of claim 1, wherein the travel of the chassis exceeds 1.7 meters per second.

10. The smart mobile elevating work system of claim 1, wherein the movement of the extending structure exceeds 0.8 meters per second.

11. The smart mobile elevating work system of claim 1, wherein slewing or rotation within the movement of the extending structure exceeds 1.4 meters per second.

12. The smart mobile elevating work system of claim 1, wherein the travel from the first position to the second position is in violation of ANSI/SAIA A92.20-2020.

13. The smart mobile elevating work system of claim 1, wherein the movement of the work platform is in violation of ANSI/SAIA A92.20-2020.

14. The smart mobile elevating work system of claim 1, wherein the chassis comprises stabilization legs, wherein the stabilization legs being positioned in stabilizing position broadens the range of the movement of the extending structure.

15. The smart mobile elevating work system of claim 1, wherein the extending structure comprises a stabilizing device, wherein the stabilizing device being positioned in stabilizing position broadens the range of the movement of the extending structure.

16. The smart mobile elevating work system of claim 1, wherein the actual values further include information corresponding with one or more stabilizing legs, a stabilizing device, or a combination thereof.

17. The smart mobile elevating work system of claim 1, wherein the actual values further include measurements corresponding with electric fields proximal to the work platform.

18. A smart mobile elevating work system for safe construction, comprising:
a chassis and an extending structure connected to the chassis, the extending structure supporting a work platform; and
means for limiting movement of the extending structure and the work platform in response to actual values for movement of the extending structure and mass supported by the work platform.

19. A smart mobile elevating work process for safe construction, comprising:
providing smart mobile elevating work system having a chassis and an extending structure connected to the chassis, the extending structure supporting a work platform; and
limiting movement of the extending structure and the work platform in response to actual values for movement of the extending structure and mass supported by the work platform.

20. Means for performing the smart mobile elevating process of claim 19.
